(19) United States
(12) Patent Application Publication
(10) Pub. No.: US 2025/0300220 A1
(43) Pub. Date: Sep. 25, 2025

(54) PREPARATION METHOD AND APPLICATION OF INTERPENETRATING SOLID ELECTROLYTE INTERFACE

(71) Applicant: Kunming University of Science and Technology, Kunming (CN)

(72) Inventors: Peng DONG, Kunming (CN); Yiyong ZHANG, Kunming (CN); Yingjie ZHANG, Kunming (CN); Xue LI, Kunming (CN); Yannan ZHANG, Kunming (CN); Jiyue HOU, Kunming (CN); Ao LI, Kunming (CN)

(21) Appl. No.: 18/947,500

(22) Filed: Nov. 14, 2024

Related U.S. Application Data
(63) Continuation of application No. PCT/CN2024/122077, filed on Sep. 28, 2024.

(30) Foreign Application Priority Data
Mar. 25, 2024 (CN) 202410340886.8

(51) Int. Cl. H01M 10/0562; H01M 4/02; H01M 4/04; H01M 4/38

(52) U.S. Cl. CPC H01M 10/0562; H01M 4/0407; H01M 4/382; H01M 2004/027; H01M 2300/0071

(57) ABSTRACT

A preparation method and an application of an interpenetrating solid electrolyte interface are provided. According to the present disclosure, a lithium metal electrode plate is prepared into a lithium oxide plating layer in an air atmosphere, and then a lithium sulfide plating layer is prepared by soaking in a lithium polysulfide plating solution, and then a lithium sulfide/lithium oxide interpenetrating solid electrolyte interface is obtained by drying at normal temperature.

### CROSS-REFERENCE TO RELATED APPLICATIONS

This application is a continuation of PCT/CN2024/122077, filed Sep. 28, 2024 and claims priority of Chinese Patent Application No. 202410340886.8, filed on Mar. 25, 2024, the entire contents of which are incorporated herein by reference.

### TECHNICAL FIELD

The present disclosure belongs to the technical field of battery materials, and more specifically relates to a preparation method and an application of an interpenetrating solid electrolyte interface.

### BACKGROUND

The problem of the world energy crisis is worsening as non-renewable energy sources such as oil and natural gas continue to be consumed. Energy is indispensable for the development of science and technology and the improvement of living standards. Due to the booming development of portable electronic devices and new energy electric vehicles, there is an urgent need for a high-capacity anode material that is applicable to high energy/power density rechargeable lithium-based batteries. This has brought lithium metal, which was marginalized in the 1990s due to the commercial value of graphite anodes and is known as the ‘holy grail’ of battery technology, back to the forefront of scientists' minds. With the highest theoretical specific capacity and lowest redox potential, lithium metal is the ultimate choice for next-generation lithium-ion batteries. However, the uncontrolled growth of lithium dendrites during the battery cycling process seriously affects the cycle stability, safety and practical application of lithium metal batteries.

Volume expansion of lithium metal anode during cycling, uneven lithium deposition, lithium dendrite growth, low coulombic efficiency, and poor long-cycle stability are difficulties that technicians in the field have been working to solve in order to achieve better battery performance.

### SUMMARY

The objective of the present disclosure is to provide a preparation method and application of an interpenetrating solid electrolyte interface. A double-layer artificial solid electrolyte interphase (SEI) structure is designed by a simple chemical redox method, which solves the problems existing in the prior art and effectively inhibits the growth of lithium dendrites during charging and discharging.

In order to achieve the above objectives, the present disclosure provides the following schemes.

One of the technical schemes of the present disclosure is to provide a preparation method of an interpenetrating solid electrolyte interface, including following steps:
preparing a lithium oxide plating layer on a lithium metal electrode plate in an air atmosphere, soaking the lithium metal electrode plate in a lithium polysulfide plating solution to prepare a lithium sulfide plating layer, and then drying to obtain the interpenetrating solid electrolyte interface.

Optionally, the lithium metal electrode plate is a polished lithium metal electrode plate.

Optionally, steps of preparing the lithium oxide plating layer include exposing the lithium metal electrode plate in an air with a humidity of 30%-80% for 1 second(s)-600 s.

Optionally, steps for preparing the lithium polysulfide plating solution include: using sublimated sulfur and lithium sulfide as solutes and electrolyte as solvent, preparing a lithium polysulfide plating solution with a concentration of 0.1-10 mole per liter (mol/L).

Optionally, a molar ratio of the sublimated sulfur to the lithium sulfide is 1-7:1.

Optionally, the electrolyte is an ether electrolyte or a lipid electrolyte.

More optionally, the ether electrolyte consists of lithium salt solute and electrolyte solvent; the lithium salt solute is at least one of lithium hexafluorophosphate (LiPF₆), lithium perchlorate (LiClO₄), lithium tetrafluoroborate (LiBF₄), lithium hexafluoroarsenate (LiAsF₆) and lithium nitrate (LiNO₃); the electrolyte solvent includes at least two of tetrahydrofuran (THF), 2-methyltetrahydrofuran (2me-thf), 1,3-dioxolane (DOL), dimethoxymethane (DMM), 1,2-dimethoxyethane (DME) and diethylene glycol dimethyl ether (DG).

More optionally, the lipid electrolyte consists of lithium salt solute and electrolyte solvent; the lithium salt solute is at least one of lithium hexafluorophosphate (LiPF₆), lithium perchlorate (LiClO₄), lithium tetrafluoroborate (LiBF₄) and lithium hexafluoroarsenate (LiAsF₆); the electrolyte solvent is at least two of ethylene carbonate (EC), propylene carbonate (PC), diethyl carbonate (DEC), dimethyl carbonate (DMC) and methyl ethyl carbonate (EMC).

Optionally, steps for preparing the lithium sulfide plating layer include: soaking the lithium metal electrode plate prepared with the lithium oxide plating layer in the lithium polysulfide plating solution for 1-600 s.

Optionally, the drying is normal temperature drying in an inert environment.

Another technical scheme of the present disclosure is to provide an interpenetrating solid electrolyte interface prepared by the preparation method.

Another technical scheme of the present disclosure is to provide an application of the interpenetrating solid electrolyte interface in lithium-ion batteries.

Another technical scheme of the present disclosure is to provide a negative electrode plate, which includes the interpenetrating solid electrolyte interface.

Another technical scheme of the present disclosure provides a full battery, including the negative electrode plate.

Another technical scheme of the present disclosure provides a symmetrical battery, which includes the negative electrode plate.

The present disclosure provides the following technical effects.

By preparing the lithium sulfide/lithium oxide interpenetrating solid electrolyte interface, the present disclosure effectively combines the capability of lithium oxide to reduce the diffusion barrier of lithium ions with the capability of lithium sulfide to inhibit the growth of lithium dendrites, and realizes the superlinear synergistic effect of 1+1>2.

The lithium sulfide/lithium oxide interpenetrating solid electrolyte interface prepared by the present disclosure improves the exchange current density and reduces the membrane resistance, thereby ensuring that lithium ions are quickly and uniformly transmitted to the electrode surface during the charging and discharging process of the battery, which is very important for high-efficiency batteries; the artificial solid electrolyte interface may also inhibit the volume expansion of lithium during the cycle, thus effectively improving the first coulombic efficiency of the battery; the interface of the artificial solid electrolyte has strong mechanical stability and a compact and uniform surface, thus effectively inhibiting the growth of lithium dendrites.

After forming a symmetrical battery or a full battery, the cycle life and long cycle stability are significantly improved.

### BRIEF DESCRIPTION OF THE DRAWINGS

The accompanying drawings, which constitute a part of this application, are used to provide a further understanding of this application. The illustrative embodiments of this application and their descriptions are used to explain this application, and do not constitute an improper limitation of this application. In the attached drawings:

FIG. 1 is a cross-sectional scanning electron microscope (SEM) image of a lithium metal electrode plate with an artificial solid electrolyte interface of lithium sulfide/lithium oxide interpenetrating type prepared in Embodiment 1;

FIG. 2 is an SEM image of a lithium metal button electrode plate with lithium oxide plating layer after 150 cycles of a lithium symmetrical battery prepared from the electrode plate of Comparative embodiment 1;

FIG. 3 is an SEM image of a lithium metal button electrode plate with lithium sulfide plating layer after 150 cycles of a lithium symmetrical battery prepared from the electrode plate of Comparative embodiment 2;

FIG. 4 is an SEM image of the lithium metal button electrode piece with an artificial solid electrolyte interface of lithium sulfide/lithium oxide interpenetrating type prepared in Embodiment 1;

FIG. 5 is an SEM image of a lithium metal button electrode plate with lithium sulfide/lithium oxide interpenetrating solid electrolyte interface after 150 cycles of the lithium symmetric battery prepared from the electrode plate of Embodiment 1;

FIG. 6 is an SEM image of the original button lithium sheet after 150 cycles of the lithium symmetric battery prepared from the original button lithium sheet of the control group;

FIG. 7 is an electrochemical impedance spectroscopy (EIS) diagram of the electrode plates of the control group and Embodiment 1 after 150 cycles at a current density of 1 mA/cm² and a cycle capacity of 1 mAh/cm²;

FIG. 8 is a Tafel diagram of the electrode plates of the control group and Embodiment 1 after 150 cycles at a current density of 1 mA/cm² and a cycle capacity of 1 mAh/cm²;

FIG. 9 shows the long-term cycle results of lithium-ion batteries prepared from the electrode plates of the control group and Embodiment 1; and

FIG. 10 shows the cycling performance of Embodiment 1 and the original ternary full battery assembled with button lithium wafers as negative electrode.

FIG. 11 illustrates the steps for preparing the lithium sulfide/lithium oxide interpenetrating solid electrolyte interface of the present disclosure.

### DETAILED DESCRIPTION OF THE EMBODIMENTS

A number of exemplary embodiments of the present disclosure will now be described in detail, and this detailed description should not be considered as a limitation of the present disclosure, but should be understood as a more detailed description of certain aspects, characteristics and embodiments of the present disclosure.

It should be understood that the terminology described in the present disclosure is only for describing specific embodiments and is not used to limit the present disclosure. In addition, for the numerical range in the present disclosure, it should be understood that each intermediate value between the upper limit and the lower limit of the range is also specifically disclosed. Intermediate values within any stated value or stated range, as well as each smaller range between any other stated value or intermediate values within the stated range are also included in the present disclosure. The upper and lower limits of these smaller ranges can be independently included or excluded from the range.

Unless otherwise specified, all technical and scientific terms used herein have the same meaning as commonly understood by one of ordinary skill in the art to which this present disclosure relates. Although the present disclosure only describes the preferred methods and materials, any methods and materials similar or equivalent to those described herein can also be used in the practice or testing of the present disclosure. All documents mentioned in this specification are incorporated by reference to disclose and describe methods and/or materials related to the documents. In case of conflict with any incorporated document, the contents of this specification shall prevail.

It is obvious to those skilled in the art that many improvements and changes may be made to the specific embodiments of the present disclosure without departing from the scope or spirit of the present disclosure. Other embodiments will be apparent to the skilled person from the description of the present disclosure. The description and embodiments of the present disclosure are exemplary only.

The terms “including”, “comprising”, “having” and “containing” used in this specification are all open terms, which means including but not limited to.

Unless otherwise specified, the room temperature/normal temperature in the embodiments of the present disclosure refers to 25+5° C.

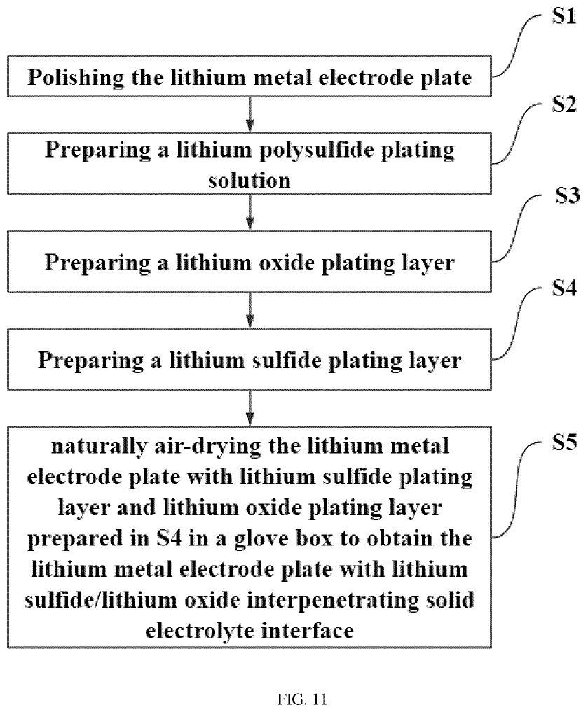

As shown in FIG. 11, the steps for preparing the lithium sulfide/lithium oxide interpenetrating solid electrolyte interface of the present disclosure include:
S1, polishing the lithium metal electrode plate
selecting a 500-4000 mesh silver polishing rod and lithium metal electrode plates which are not oxidized; polishing the surface of the lithium metal electrode plate to silver brightness with a silver polishing rod;
S2, preparing lithium polysulfide plating solution
dissolving sublimed sulfur and lithium sulfide in ether or lipid electrolyte according to the molar ratio of 1-7:1 to prepare lithium polysulfide plating solution with the concentration of 0.1-10 mol/L;
the ether electrolyte consists of lithium salt solute and electrolyte solvent; the lithium salt solute is at least one of lithium hexafluorophosphate (LiPF₆), lithium perchlorate (LiClO₄), lithium tetrafluoroborate (LiBF₄), lithium hexafluoroarsenate (LiAsF₆) and lithium nitrate (LiNO₃); the electrolyte solvent includes at least two of tetrahydrofuran (THF), 2-methyltetrahydrofuran (2me-thf), 1,3-dioxolane (DOL), dimethoxymethane (DMM), 1,2-dimethoxyethane (DME) and diethylene glycol dimethyl ether (DG);
the lipid electrolyte consists of lithium salt solute and electrolyte solvent; The lithium salt solute is at least one of lithium hexafluorophosphate (LiPF₆), lithium perchlorate (LiClO₄), lithium tetrafluoroborate (LiBF₄), and lithium hexafluoroarsenate (LiAsF₆); the electrolyte solvent includes at least two of ethylene carbonate (EC), propylene carbonate (PC), diethyl carbonate (DEC), dimethyl carbonate (DMC) and methyl ethyl carbonate (EMC);
S3, preparing a lithium oxide plating layer
exposing the polished lithium metal electrode plate in step S1 to air at room temperature for 1 s-600 s, with an air humidity of 30%-80%, preferably 1 s to 300 s;
S4, preparing a lithium sulfide plating layer;
soaking the lithium metal electrode plate prepared with lithium oxide plating layer obtained in step S3 in lithium polysulfide plating solution prepared in step S2 for 1-600 s, preferably for 1-300 s; and
S5, naturally air-drying the lithium metal electrode plate with lithium sulfide plating layer and lithium oxide plating layer prepared in S4 in a glove box to obtain the lithium metal electrode plate with lithium sulfide/lithium oxide interpenetrating solid electrolyte interface.

In the specific embodiments, the molar ratio of sublimed sulfur to lithium sulfide is 1:1, but it should be noted that the ratio range of 1-7:1 defined in the present disclosure is selected in order to completely react lithium sulfide. Based on the preparation method and principle of lithium polysulfide, it has little influence on the final lithium polysulfide coating, and may be replaced equally.

In a specific embodiment, an inert gas atmosphere is provided by the glove box.

### Embodiment 1

Preparation of electrode plate with interpenetrating solid electrolyte interface:
S1, polishing the lithium metal electrode plate
selecting a lithium metal button electrode plate with a thickness of 1.2 mm and a diameter of 15 mm, and polishing with a silver polishing rod (mesh number of 2000) in a glove box;
S2, preparing a lithium polysulfide plating solution
taking 1000 mL of electrolyte (1.0 M LiTFSI in DOL:DME=3:5 vol % with 1.2% LiNO₃) using a pipette in a glove box, placing in a glass bottle and sealing well; weighing 0.2 mol of sublimated sulfur and 0.2 mol of lithium sulfide, and pouring into a glass bottle containing 1000 mL of electrolyte in turn; then putting a clean rotor into the glass bottle and sealing the glass bottle with sealing glue; stirring in a magnetic stirrer for 4 days with a rotating speed of 600 rpm, where the final plating solution concentration is 0.2 mol/L;
S3, preparing a lithium oxide plating layer
taking the polished lithium metal button electrode plate in S1 out of the glove box and exposing it to air (room temperature, humidity 40%) for 150 s; and then quickly putting into a glove box;
S4, preparing a lithium sulfide plating layer
soaking the lithium metal button electrode plate with lithium oxide plating layer obtained in S3 in the lithium polysulfide plating solution prepared in S2 for 200 s; and
S5, naturally air-drying the lithium metal electrode plate with lithium sulfide plating layer and lithium oxide plating layer prepared in S4 in a glove box for 5 h to obtain the lithium metal electrode plate with lithium sulfide/lithium oxide interpenetrating solid electrolyte interface.

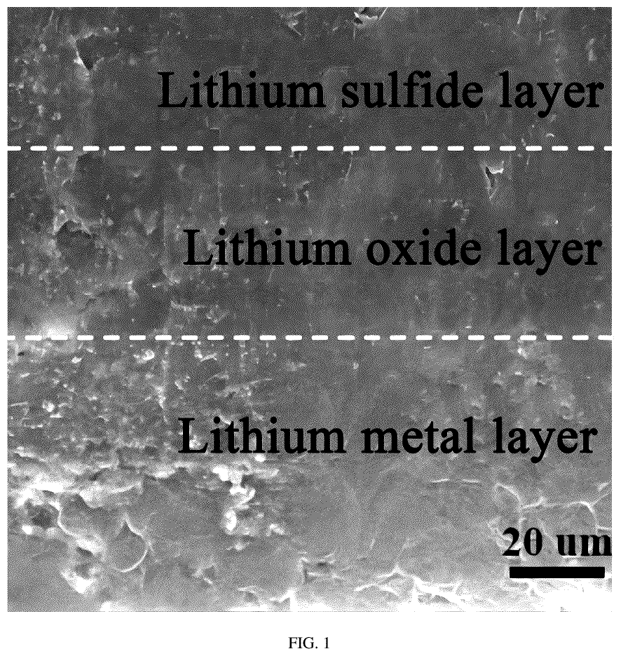

The cross-sectional SEM image of a lithium metal electrode plate with an artificial solid electrolyte interface of lithium sulfide/lithium oxide interpenetrating type is shown in FIG. 1. It may be seen that the interface between the lithium metal layer and the lithium oxide layer is flat and has no expansion.

### Embodiment 2

Preparation of electrode electrode plate with interpenetrating solid electrolyte interface:
S1, polishing the lithium metal electrode plate
selecting a lithium metal button electrode plate with a thickness of 1.2 mm and a diameter of 15 mm, and polishing with a silver polishing rod (mesh number of 2500) in a glove box;
S2, preparing a lithium polysulfide plating solution
taking 1000 mL of electrolyte (1.0 M LiPF6 in EC: DMC: EMC=5:3:2 Vol %) using a pipette in a glove box, placing in a glass bottle and sealing well; weighing 0.3 mol of sublimated sulfur and 0.3 mol of lithium sulfide, and pouring into a glass bottle containing 1000 mL of electrolyte in turn; then putting a clean rotor into the glass bottle and sealing the glass bottle with sealing glue; stirring in a magnetic stirrer for 5 days with a rotating speed of 700 rpm, where the final plating solution concentration is 0.3 mol/L;
S3, preparing a lithium oxide plating layer
taking the polished lithium metal button electrode plate in S1 out of the glove box and exposing it to air (room temperature, humidity 45%) for 210 s; and then quickly putting into a glove box;
S4, preparing a lithium sulfide plating layer
soaking the lithium metal button electrode plate with lithium oxide plating layer obtained in S3 in the lithium polysulfide plating solution prepared in S2 for 250 s; and
S5, naturally air-drying the lithium metal electrode plate with lithium sulfide plating layer and lithium oxide plating layer prepared in S4 in a glove box for 7 h to obtain the lithium metal electrode plate with lithium sulfide/lithium oxide interpenetrating solid electrolyte interface.

### Embodiment 3

Preparation of electrode plate with interpenetrating solid electrolyte interface:
S1, polishing the lithium metal electrode plate
selecting a lithium metal button electrode plate with a thickness of 1.2 mm and a diameter of 15 mm, and polishing with a silver polishing rod (mesh number of 3000) in a glove box;
S2, preparing a lithium polysulfide plating solution
taking 1000 mL of electrolyte (1.0 M LiPF₆ in EC: DMC: EMC=4:3:3 Vol %) using a pipette in a glove box, placing in a glass bottle and sealing well; weighing 0.5 mol of sublimated sulfur and 0.5 mol of lithium sulfide, and pouring into a glass bottle containing 1000 mL of electrolyte in turn; then putting a clean rotor into the glass bottle and sealing the glass bottle with sealing glue; stirring in a magnetic stirrer for 6 days with a rotating speed of 750 rpm, where the final plating solution concentration is 0.5 mol/L;
S3, preparing a lithium oxide plating layer
taking the polished lithium metal button electrode plate in S1 out of the glove box and exposing it to air (room temperature, humidity 50%) for 230 s; and then quickly putting into a glove box;
S4, preparing a lithium sulfide plating layer
soaking the lithium metal button electrode plate with lithium oxide plating layer obtained in S3 in the lithium polysulfide plating solution prepared in S2 for 300 s; and
S5, naturally air-drying the lithium metal electrode plate with lithium sulfide plating layer and lithium oxide plating layer prepared in S4 in a glove box for 10 h to obtain the lithium metal electrode plate with lithium sulfide/lithium oxide interpenetrating solid electrolyte interface.

### Comparative Embodiment 1

Preparation of electrode plate with solid electrolyte interface:
S1, polishing the lithium metal electrode plate
selecting a lithium metal button electrode plate with a thickness of 1.2 mm and a diameter of 15 mm, and polishing with a silver polishing rod (mesh number of 2000) in a glove box; and
S2, preparing a lithium oxide plating layer
taking the polished lithium metal button electrode plate in S1 out of the glove box, exposing to air (room temperature, humidity 40%) for 150 s, and then quickly placing into a glove box to obtain the lithium metal electrode plate with artificial solid electrolyte interface.

### Comparative Embodiment 2

Preparation of electrode plate with solid electrolyte interface:
S1, polishing the lithium metal electrode plate
selecting a lithium metal button electrode plate with a thickness of 1.2 mm and a diameter of 15 mm, and polishing with a silver polishing rod (mesh number of 2500) in a glove box;
S2, preparing a lithium polysulfide plating solution
taking 1000 mL of electrolyte (1.0 M LiPF₆ in EC: DMC: EMC=5:3:2 Vol %) using a pipette in a glove box, placing in a glass bottle and sealing well; weighing 0.2 mol of sublimated sulfur and 0.2 mol of lithium sulfide, and pouring into a glass bottle containing 1000 mL of electrolyte in turn; then putting a clean rotor into the glass bottle and sealing the glass bottle with sealing glue; stirring in a magnetic stirrer for 4 days with a rotating speed of 600 rpm, where the final plating solution concentration is 0.2 mol/L;
S3, preparing a lithium sulfide plating layer
soaking the polished lithium metal button electrode plate in S1 in the lithium polysulfide plating solution prepared in S2 for 200 s; and
S4, naturally air-drying the lithium metal electrode plate with lithium sulfide plating layer prepared in S3 in a glove box for 5 h to obtain the lithium metal electrode plate with artificial solid electrolyte interface.

### TEST EMBODIMENTS

### Electrochemical Performance Test

### 1. Symmetric Battery

The electrode plates prepared in Embodiment 1 and Comparative embodiments 1-2 and the original button lithium sheet are respectively used as negative electrode materials to form a lithium symmetrical battery, and the original button lithium sheet group is used as the control group.

The surface morphology of the assembled lithium symmetric battery is characterized after 150 cycles at a current density of 1 mA/cm² and a cycle capacity of 1 mAh/cm².

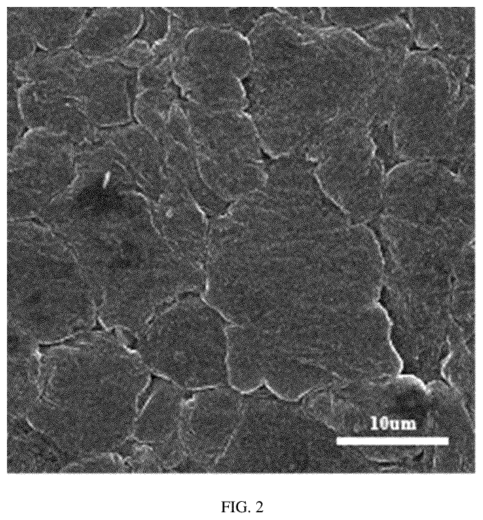

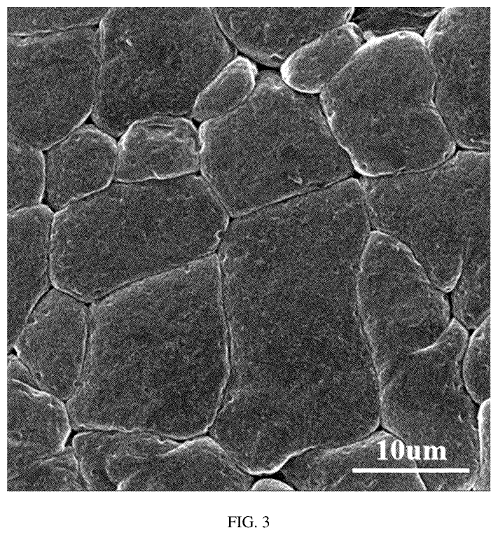

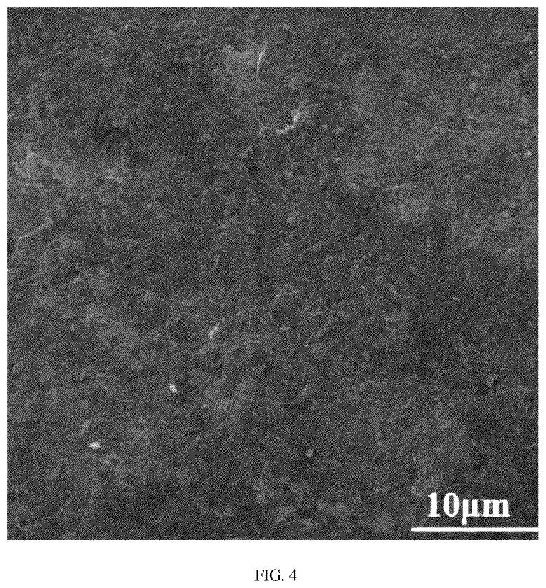

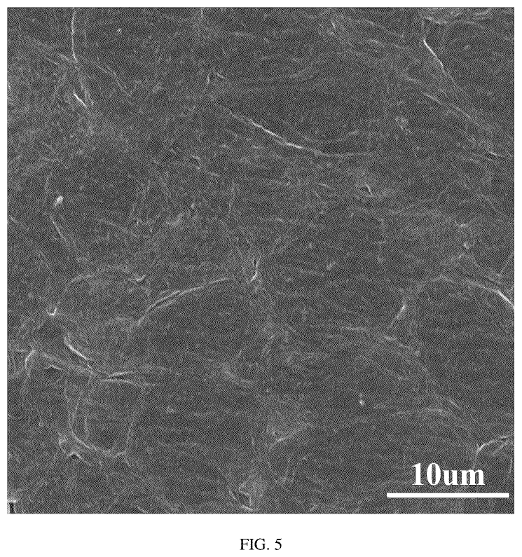

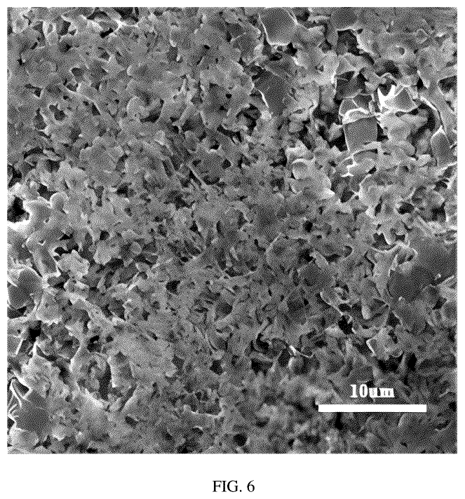

FIG. 2 is an SEM image of a lithium metal button electrode plate with lithium oxide plating layer after 150 cycles of a lithium symmetrical battery prepared from the electrode plate of Comparative embodiment 1; FIG. 3 is an SEM image of a lithium metal button electrode plate with lithium sulfide plating layer after 150 cycles of a lithium symmetrical battery prepared from the electrode plate of Comparative embodiment 2; FIG. 4 is the SEM image of the lithium metal button electrode plate with lithium sulfide/lithium oxide interpenetrating solid electrolyte interface prepared in Embodiment 1; FIG. 5 is a SEM image of a lithium metal button electrode plate with lithium sulfide/lithium oxide interpenetrating solid electrolyte interface after 150 cycles of the lithium symmetric battery prepared from the electrode plate of Embodiment 1; and FIG. 6 is the SEM image of the original button lithium sheet after 150 cycles of the lithium symmetric battery prepared from the original button lithium sheet of the control group. It may be seen from FIGS. 2-6 that this artificial solid electrolyte interface may effectively inhibit the generation of lithium dendrites (the SEM images of Embodiments 2 and 3 are basically the same as those of Embodiment 1).

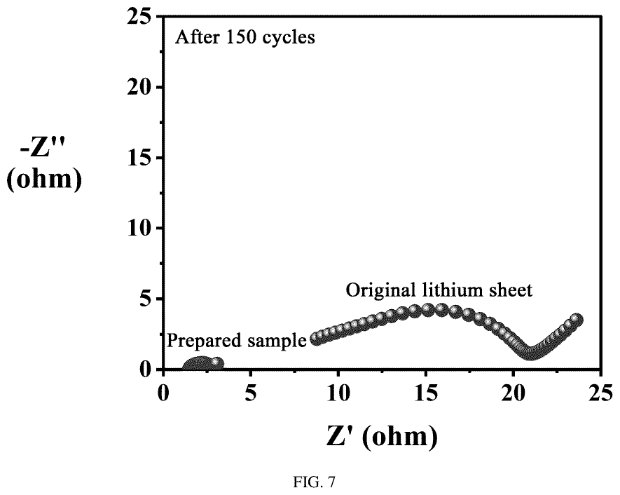

The EIS diagrams of the electrode plates of the control group and Embodiment 1 after 150 cycles under the conditions of current density of 1 mA/cm² and cycle capacity of 1mAh/cm² are shown in FIG. 7. It may be seen that the double-layer artificial SEI structure designed by the present disclosure may effectively reduce the membrane resistance.

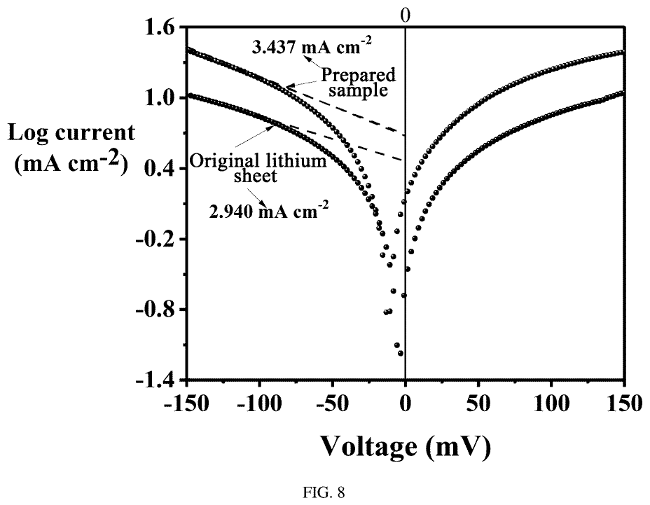

The Tafel images of the electrode plates of the control group and Embodiment 1 after 150 cycles under the conditions of current density of 1 mA/cm² and cycle capacity of 1mAh/cm² are shown in FIG. 8. It may be seen that the double-layer artificial SEI structure designed by the present disclosure may effectively improve the exchange current density.

The assembled lithium symmetrical batteries are tested under the current density of 2 mA/cm² and the cycle capacity of 5 mAh/cm².

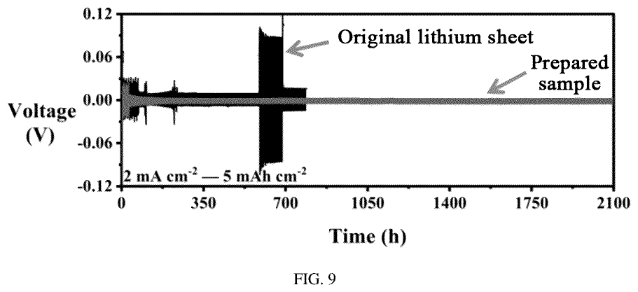

FIG. 9 shows the long-term cycle results of lithium symmetric batteries prepared by the electrode plates of the control group and Embodiment 1. As may be seen from FIG. 9, the double-layer artificial SEI structure designed by the present disclosure may effectively reduce the cycle overpotential and increase the cycle life.

### 2. Ternary Battery

Ternary full battery assembly and testing: according to the mass ratio of 8:1:1, ternary NCM811, PVDF and Super-P are added into NMP solution in turn, stirred for 4 h to obtain uniformly dispersed slurry, which is coated onto aluminum foil, and then dried in a vacuum oven at 70°° C. for 12 h, and the obtained sample is cut to a suitable size as required, thus obtaining ternary electrode plates. Then, a ternary battery is assembled and tested with ternary electrode plates as the positive electrode and Embodiment 1 and the original button lithium sheet as the negative electrode.

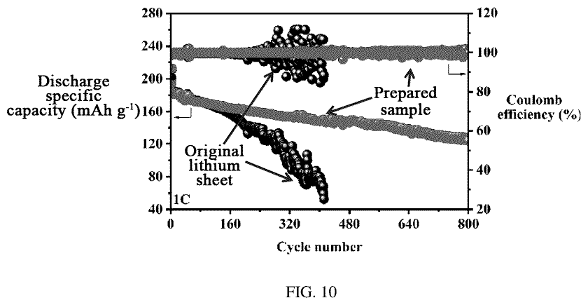

FIG. 10 shows the cycling performance of the ternary full battery assembled with Embodiment 1 and the original button lithium sheet as the negative electrode. It may be seen from FIG. 10 that the double-layer artificial SEI structure designed by the present disclosure may effectively improve the cycle life and cycle capacity.

Each embodiment in this specification is described in a progressive way, and each embodiment focuses on the differences from other embodiments, so it is only necessary to refer to the same and similar parts between each embodiment.

The above description of the disclosed embodiments enables those skilled in the art to make or use the present disclosure. Many modifications to these embodiments will be obvious to those skilled in the art, and the general principles defined herein can be implemented in other embodiments without departing from the spirit or scope of the present disclosure. Therefore, the present disclosure is not to be limited to the embodiments shown herein, but is to be accorded the widest scope consistent with the principles and novel features disclosed herein.

What is claimed is:

1. An interpenetrating solid electrolyte interface, wherein steps for preparing the interpenetrating solid electrolyte interface comprise:
preparing a lithium oxide plating layer on a lithium metal electrode plate in an air atmosphere, soaking the lithium metal electrode plate in a lithium polysulfide plating solution to prepare a lithium sulfide plating layer, and then drying to obtain the interpenetrating solid electrolyte interface;
wherein steps for preparing the lithium oxide plating layer comprise: exposing the lithium metal electrode plate in an air with a humidity of 30%-80% for 1 s-600 s;
steps for preparing the lithium polysulfide plating solution comprise: using sublimated sulfur and lithium sulfide as solutes and electrolyte as solvent to prepare a lithium polysulfide plating solution with a concentration of 0.1-10 mol/L; and
a molar ratio of the sublimated sulfur to lithium sulfide is 1-7:1; and the electrolyte is ether electrolyte or lipid electrolyte.

2. The interpenetrating solid electrolyte interface according to claim 1, wherein steps for preparing the lithium sulfide plating layer comprise: immersing the lithium metal electrode plate prepared with the lithium oxide plating layer in the lithium polysulfide plating solution for 1 s-600 S.

3. A negative electrode plate, comprising the interpenetrating solid electrolyte interface according to claim 1.

4. A full battery, comprising the negative electrode plate according to claim 3.
